(19) United States
(12) Patent Application Publication
(10) Pub. No.: US 2018/0252032 A1
(43) Pub. Date: Sep. 6, 2018

(54) FASTENING SYSTEM FOR A DECORATIVE VALANCE OF A ROLLER SHADE AND/OR BLIND AND A DECORATIVE VALANCE OF A CURTAIN PROVIDED WITH A FASTENING SYSTEM

(71) Applicant: Bandalux Industrial, S.A., Barcelona (ES)

(72) Inventor: Emiliano GARCIA GARCIA, Barcelona (ES)

(21) Appl. No.: 15/447,217

(22) Filed: Mar. 2, 2017

(51) Int. Cl. E06B 9/42

(52) U.S. Cl. CPC E06B 9/42

(57) ABSTRACT

A fastening system for a decorative valance of a roller shade and/or blind, in which the decorative valance is comprised of a front panel and side panels, defining an inner housing, a housing in which there is a rotating roller to which a band of the roller shade is coupled, the rotating roller being connected to drive means that act on the rotating roller. This fastening system comprises an anchoring element that has a first coupling region configured to be coupled to a wall or ceiling, a second region provided with coupling means provided for supporting the drive means of the rotating roller, and guide means configured to attach one of the side panels of the decorative valance.

### OBJECT OF THE INVENTION

The object of the present invention is to provide a fastening system for a decorative valance of a roller shade and/or blind.

More specifically, the invention proposes the development of a fastening system for a decorative valance of a shade and/or blind that is easy to manufacture and install, particularly provided for a decorative valance comprising a front panel and side panels, defining an inner housing, a housing in which there is a rotating roller connected to a band of the roller shade, the roller being connected to drive means that act on the rotating roller, that being provided with an anchoring element that simultaneously attaches the roller and the decorative valance to a wall or ceiling without additional attachment elements.

### FIELD AND BACKGROUND OF THE INVENTION

Currently, there are known to be various assembly and fastening systems provided for attaching a box or decorative valance of a roller shade to a wall or ceiling of a facility, inside of which there are mechanisms for driving a rotating roller that incorporates the shade itself. An example of a decorative shade valance is described in the Spanish patent application no. ES 2350774, U.S. Pat. No. 9,062,493 or U.S. Pat. No. 8,820,386. All these systems are similar in that they require different pieces to independently join the drawer or decorative valance to the side wall or ceiling, as well as additional means to couple the roller to the decorative valance.

Nevertheless, since the known fastening systems use a large number of pieces and components to attach each one of the parts that form part of the assembly of the roller shade or blind, the manufacturing costs increase when a greater number of molds and equipment must be used to manufacture those pieces. Furthermore, another disadvantage, due to the high number of elements involved in attachment, is the fact that it is difficult for an installer to mount the assembly of the roller shade on the wall or ceiling and, therefore, the installation tasks are more cumbersome, thus implying a longer assembly time.

### DESCRIPTION OF THE INVENTION

The present invention has been developed with the aim of providing a fastening system that constitutes a novelty within the field of application, and solves the disadvantages mentioned above while also contributing other additional advantages, which will become evident from the description provided below.

Therefore, an object of the present invention is to provide a fastening system for a decorative valance of a roller shade, particularly provided for a decorative valance comprising a front panel and side panels, defining an inner housing, a housing in which there is a rotating roller to which a band of the roller shade or blind is coupled, the roller being connected to drive means that act on the rotating roller.

In particular, the invention is characterized in that it comprises an anchoring element that has a first coupling region configured to couple to a wall or ceiling, a second region provided with coupling means provided for supporting the drive means of the rotating roller, and guide means configured to attach one of the side panels of the decorative valance.

Thanks to these characteristics, it is possible to reduce the number of pieces that form part of a decorative valance of a roller shade, since the anchoring element has a dual function: on one hand, it supports the decorative valance of the roller shade on the wall or ceiling, and the other hand, it supports the rotating roller located inside the decorative valance. This way, it is easier for an installer to assemble the decorative valance, thus reducing the assembly time.

Another equally important advantage of the system of the invention is that it allows the decorative valance of a roller shade to be attached to a wall or the ceiling, which implies that it does not use different pieces depending on the final location of the decorative shade valance.

According to another aspect of the invention, in which the anchoring element is made up of a laminar body with a central axis of symmetry that defines two symmetrical parts identical to each other, which has a first flap upon which the first region is arranged, and a second flap, folded at a right angle with respect to the first flap, upon which the second region and the fastening means are arranged.

This constructive design of the anchoring element allows the drive means (driven by a motor or a chain) of the roller shade to be arranged interchangeably on the right or left side of the decorative valance, therefore being a system with a greater degree of versatility.

Particularly, the first region has at least one through hole configured for the passage of screw elements provided for attachment to the wall or ceiling.

Advantageously, the through hole is a slotted hole, such that this design allows the installer or assembler to easily and quickly adjust the position of the decorative valance once the screws or pins are partially inserted into a hole made in the wall or ceiling.

In a particularly preferred embodiment, the first region comprises a pair of through holes separated from each other.

According to another characteristic of the fastening system, the second flap, where the second region is arranged, has a through hole on one of its faces, around which a plurality of tabs distributed radially around the through hole project outwards.

Preferably, the guide means comprise protrusions that project from each one of the sides of the second flap, said protrusions being configured to couple to the rails present on the inner face of the side panels of the decorative valance.

Additionally, there are gripping means located in the second region which are configured to keep the element firmly attached to the side panel of the decorative valance.

In an embodiment of the invention, the aforementioned gripping means can comprise screws that pass through corresponding through holes that are located on the second flap of the anchoring element, those through holes being located at the corners.

Preferably, the anchoring element is made from a metal material which provides good mechanical characteristic of resistance and strength.

Another object of the invention is to provide a decorative shade valance that comprises a front panel, a pair of side panels joined by means of the front panel, defining an inner housing, a housing in which there is a rotating roller to which the roller shade is coupled, the roller being connected to drive means that act on the rotating roller, wherein it comprises a pair of fastening systems, as above explained, which are arranged on opposite ends of the decorative valance.

Other characteristics and advantages of the fastening system, object of the present invention, will become clear in light of the description of a preferred, though non-exclusive, embodiment, which, by way of a non-limiting example, is illustrated in the accompanying drawings, wherein:

### BRIEF DESCRIPTION OF THE SEVERAL VIEWS OF THE DRAWINGS

FIG. 1 shows an exploded perspective view of a decorative valance of a roller shade provided for the fastening system according to the present invention;

FIG. 2 shows a rear perspective view of a first embodiment of an anchoring element that forms part of the fastening system;

FIG. 3 shows a front perspective view of a second embodiment of the anchoring element;

FIG. 4 shows a front elevation view of a segment of a side panel of the decorative valance, provided with the anchoring element;

FIG. 5 shows a side elevation view of the segment of the side panel with the anchoring element; and

FIG. 6 shows an exploded schematic perspective view of a second embodiment of a roller shade assembly with the fastening system of the invention, wherein the rotating roller is driven without a motor, such that it is driven manually.

### DESCRIPTION OF SPECIFIC EMBODIMENTS OF THE INVENTION

In view of the aforementioned figures and, in accordance with the numbering adopted, an example of a preferred embodiment of the invention can be observed therein, which comprises the parts and elements indicated and described in detail below.

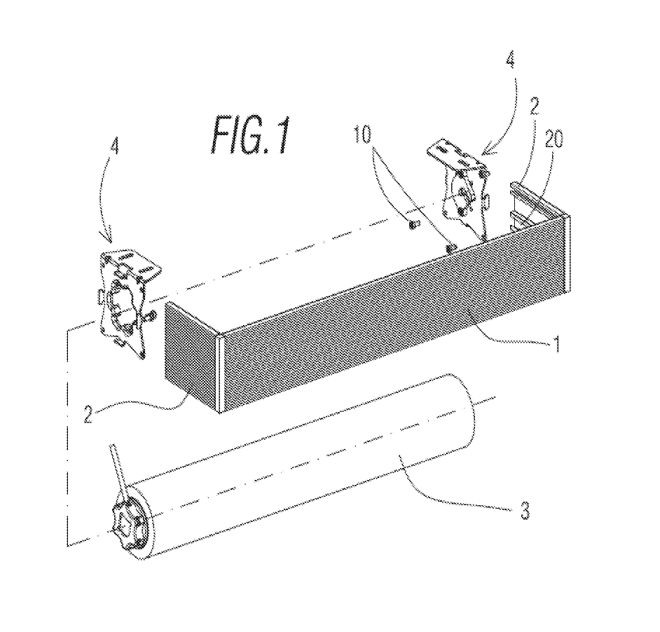

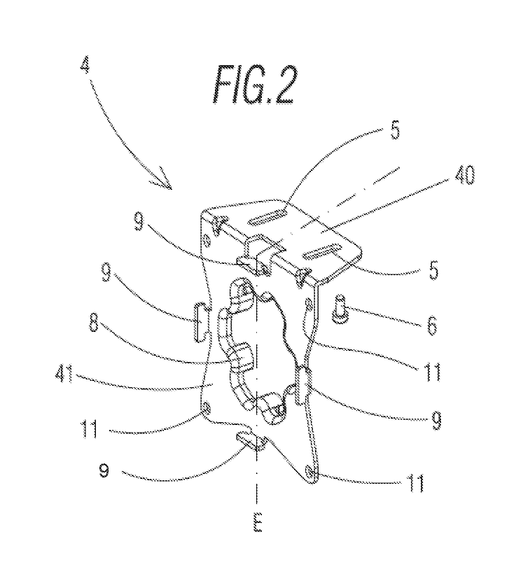

FIG. 1 schematically shows a decorative shade valance that is provided with a pair of fastening systems located on two ends facing each other. The decorative valance is comprised of a front panel 1 of a rectangular shape, a pair of side panels facing each other 2, 2′ and joined to the front panel 1, the front panel 1 and the side panels 2, 2′ defining an inner housing, a housing in which there is a rotating roller 3 (driven manually or by a motor) to which the band of the roller shade or blind is coupled.

Each one of the fastening systems comprises an anchoring element, indicated generally with the reference 4, which has a first coupling region configured to be coupled to a wall or ceiling, a second region provided with coupling means provided for supporting the drive means of the rotating roller 3, and guide means (that are described further on) which are configured to attach one of the side panels of the decorative valance. In the present exemplary embodiment, the anchoring elements 4 are turned such that they attach to a ceiling.

Specifically, the anchoring element 4 is made up of a perforated laminar body defined by a central axis of symmetry E that defines two equal parts, symmetrical to each other, made from a metal material, a first flap 40 having an essentially square shape upon which the first region is arranged and a second flap 41 with an essentially rectangular shape, being folded at a right angle with respect to the first flap 40. The second region, as well as the fastening means, are arranged on this second flap 41. It is worth mentioning that in general the first flap 40 has small dimensions with respect to the second flap 41 of the laminar body. The fact that the anchoring element 4 has two equal, symmetrical parts allows that anchoring element 4 to attach to a ceiling or a wall.

In particular reference to the first region, it has at least one pair of slotted through holes 5 separated from each other that are configured to allow the passage of corresponding screw elements 6, which are provided for attachment to holes made in the wall or ceiling.

It can be seen how the second flap 41, wherein the second region is arranged, has a through hole 7 on one of its faces, around which a plurality of tabs 8 distributed radially around that through hole 7 project outwards. This hole 7 is provided to couple with an end of the rotating roller 3.

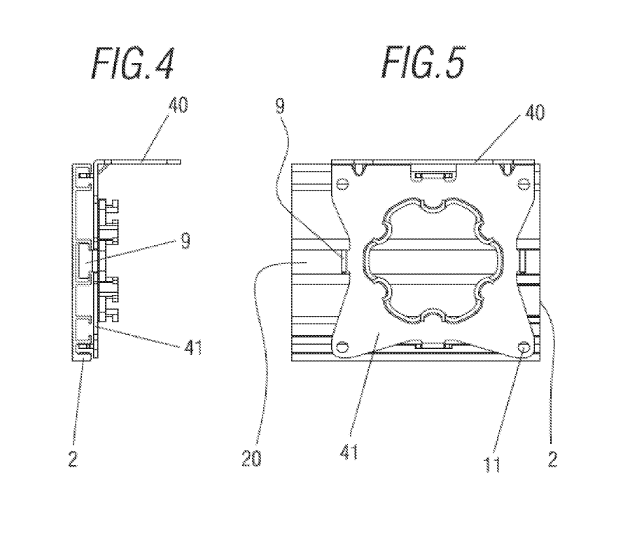

With regards to the guide means, they comprise four protrusions 9 in a “T” shape that project from a plane perpendicular to each one of the sides of the second flap 41 of the anchoring element 4, said protrusions 9 being configured to couple to guides 20 arranged longitudinally along the inner face of each one of the side panels 2 of the decorative valance (see FIGS. 1, 4 and 5).

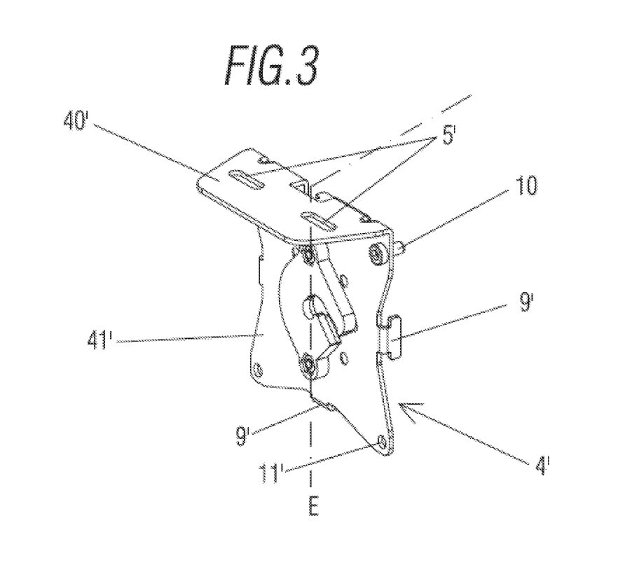

FIG. 3 shows a second variation of the anchoring element 4′ that is essentially different from the second flap 41′ in that it lacks the hole 7, wherein an accessory to couple to the opposite end of the rotating roller 3 is included.

Furthermore, the fastening system is provided with gripping means located in the second region which are configured to keep the anchoring element 4 attached to the side panel of the decorative valance. These gripping means essentially comprise screws 10 that pass through the respective through holes 11 located on the second flap 41, the through holes 11 being located on each one of the corners of that second flap 41.

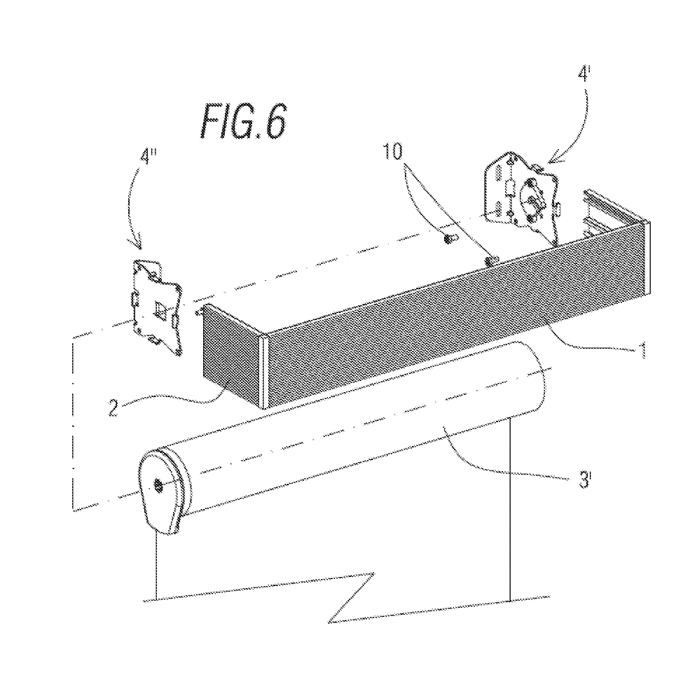

Finally, FIG. 6 shows a second assembly of a roller shade that comprises a rotating roller 3′ located inside the decorative valance, wherein each one of its two ends are supported by means of an anchoring element 4, 4′. Each one of the anchoring elements 4′, 4″ also support a respective side panel 2, 2′ and they are turned in order to be attached to a vertical wall, unlike the assembly shown in FIG. 1. In this exemplary embodiment, the rotating roller 3 is designed to be driven by chain.

What is claimed is:

1. A fastening system for a decorative valance of a roller shade and/or blind, in which the decorative valance is comprised of a front panel and side panels, defining an inner housing, a housing in which there is a rotating roller to which a band of the roller shade is coupled, the rotating roller being connected to drive means that act on the rotating roller, wherein it comprises an anchoring element that has a first coupling region configured to be coupled to a wall or ceiling, a second region provided with coupling means provided for supporting the drive means of the rotating roller, and guide means configured to attach one of the side panels of the decorative valance.

2. The fastening system according to claim 1, wherein the anchoring element is made up of a laminar body with a central axis of symmetry that defines two symmetrical parts identical to each other, which has a first flap upon which the first region is arranged, and a second flap, folded at a right angle with respect to the first flap, upon which the second region and the fastening means are arranged.

3. The fastening system according to claim 1, wherein the first region has at least one through hole configured for the passage of screw elements provided for attachment to the wall or ceiling.

4. The fastening system according to claim 3, wherein the through hole is a slotted hole.

5. The fastening system according to claim 3, wherein the first region comprises a pair of through holes separated from each other.

6. The fastening system according to claim 2, wherein the second flap, where the second region is arranged, has a through hole on one of its faces, around which a plurality of tabs distributed radially around the through hole project outwards.

7. The fastening system according to claim 1, wherein the guide means comprise protrusions that project from each one of the sides of the second flap, said protrusions being configured to couple to guides arranged longitudinally on the inner face of the side panels of the decorative valance.

8. The fastening system according to claim 1, wherein there are gripping means located in the second region which are configured to keep the anchoring element (4) attached to the side panel of the decorative valance.

9. The fastening system according to claim 8, wherein the gripping means comprise screws that pass through through holes located on the second flap, the through holes being located on the corners of that second flap.

10. The fastening system according to claim 1, wherein the anchoring element is made up of a metal material.

11. A decorative shade valance that comprises a front panel and side panels, defining an inner housing, a housing in which there is a rotating roller to which the roller shade is coupled, the roller being connected to drive means that act on the rotating roller, wherein it comprises a pair of fastening systems, according to claim 1, which are arranged on opposite ends of the decorative valance.
